(19) United States
(12) Patent Application Publication
(10) Pub. No.: US 2024/0375493 A1
(43) Pub. Date: Nov. 14, 2024

(54) ARRANGEMENT FOR MOVING A COVER FOR A VEHICLE ROOF AND VEHICLE ROOF

(71) Applicant: Webasto SE, Stockdorf (DE)

(72) Inventors: Nikolaus Georg EGER, Stockdorf (DE); Christian KNOP, Stockdorf (DE); Rudolf DIETL, Stockdorf (DE)

(21) Appl. No.: 18/657,235

(22) Filed: May 7, 2024

(30) Foreign Application Priority Data
May 9, 2023 (DE) 102023112156.1
Apr. 29, 2024 (DE) 102024111959.4

(51) Int. Cl. B60J 7/043; B60J 7/057

(52) U.S. Cl. CPC B60J 7/0435; B60J 7/057

(57) ABSTRACT

An arrangement for moving a cover for a vehicle roof has a guide rail which extends in a longitudinal direction, and a deployment lever which is fixedly coupled to the guide rail so that the deployment lever can be pivoted relative to the guide rai in order to move the cove, a deployment carriage which is guided in the guide rail so as to be displaceable in the longitudinal direction. The deployment lever and the deployment carriage are coupled together by a joint mechanism in order to transfer a displacement of the deployment carriage into a pivoting of the deployment lever. The joint mechanism has at least four rotary joints.

### CROSS-REFERENCE TO RELATED APPLICATION(S)

This application claims the benefit of German Patent Application No. 102023112156.1 filed May 9, 2023, and German Patent Application No. 102024111959.4 filed Apr. 29, 2024, both of which are incorporated herein by reference in their entireties.

### TECHNICAL FIELD

An arrangement for moving a cover for a vehicle roof is specified, in particular for a movable cover for closing a roof opening of the vehicle roof. A vehicle roof for a motor vehicle is also specified, in particular a vehicle roof which has an arrangement described herein.

### BACKGROUND

Arrangements with a movable cover for a vehicle roof can be designed as a so-called externally guided sliding roof, as described for example in DE 197 13 347 C2. Alternatively, it is also possible to design the vehicle roof as a so-called spoiler roof, as described for example in DE 10 2012 106 545 A1.

### SUMMARY

It is desirable to specify an arrangement for a vehicle roof which permits a reliable operation. It is also desirable to specify a vehicle roof which permits a reliable operation.

According to at least one embodiment, an arrangement for a vehicle roof is specified. The arrangement is configured to move a cover for the vehicle roof. The arrangement has a guide rail. The guide rail extends so as to be longitudinally extended in a longitudinal direction. The arrangement has a deployment lever. The deployment lever is fixedly coupled to the guide rail. The deployment lever and the guide rail are coupled together such that the deployment lever can be pivoted relative to the guide rail. The cover can be moved by pivoting the deployment lever. The arrangement has a deployment carriage. The deployment carriage is guided in the guide rail so as to be displaceable in the longitudinal direction. The arrangement has a joint mechanism in order to transfer a displacement of the deployment carriage along the guide rail into a pivoting of the deployment lever, wherein the joint mechanism has at least four rotary joints. In particular, the components of the joint mechanism and/or the arrangement are pivotably connected together by means of the rotary joints. The components are, in particular, levers, sliding members and sliders.

The arrangement with the joint mechanism forms, in particular, a deployment mechanism in the manner of a four-bar linkage. The coupling of the components together is such that the deployment lever is pivoted with a longitudinal displacement of the deployment carriage. This pivoting in turn serves, in particular, for lifting and lowering a trailing edge of the cover in a upward direction. The upward direction runs, in particular, transversely or perpendicularly to the longitudinal direction. A guide slider for pivoting the deployment lever can be dispensed with due to the rotary joints of the joint mechanism. This permits, in particular, a low-friction operation and reliable defined forces during the pivoting movement.

In each case, at the start and at the end of the movement for pivoting the deployment lever, higher lever forces can be achieved and a higher movement speed therebetween. This is possible, in particular, when the speed of the drive remains the same, i.e. for example when the speed of the deployment carriage remains the same. The respective end position can be achieved in a reliable manner as desired and can be reliably held.

The joint mechanism permits the use of relatively heavy covers which, for example, have a weight of 10 kg or more, in particular 12 kg or more, for example between 10 kg and 20 kg, in particular between 12 kg and 18 kg or between 12 kg and 15 kg. For example, the cover has a weight of more than 12 kg and less than 13 kg.

The joint mechanism permits sufficiently large closing forces when closing at high speeds. An enlarged cover surface, for example with a greater cover mass, also requires higher closing forces, wherein the larger mass assists with the closure.

The pivoting of the deployment lever can be implemented with relatively small drive forces and, in particular, with known drive forces. This also permits improved obstacle detection, in particular, such as for example improved anti-trap protection. The adaptation of tolerances between the individual levers and in the arrangement as a whole is possible in a reliable manner over the service life. Error analysis is possible in a reliable and efficient manner. The coupling of the levers together also permits a good level of stiffness of the arrangement in a transverse direction. The transverse direction is oriented transversely or perpendicularly to the longitudinal direction and to the upward direction.

The cover, in particular, can be displaced relative to the deployment lever in the longitudinal direction along the guide rail. Thus the arrangement is configured, for example, for a so-called spoiler roof. The deployment lever can also be denoted as the rear deployment lever.

According to at least one embodiment, the arrangement has a first lever. The first lever has a first end and an opposing second end. The arrangement has a second lever. The second lever has a third end and an opposing fourth end. The arrangement has a third lever. The third lever has a fifth end and an opposing sixth end. For example, two or more levers of the levers are pivotably connected together by means of one of the rotary joints of the joint mechanism. Alternatively or additionally, for example, at least one of the levers is pivotably fastened to the guide rail by means of at least one rotary joint of the joint mechanism. Alternatively or additionally, for example, at least one of the levers is pivotably fastened by means of at least one rotary joint of the joint mechanism to one of the sliding members.

The first lever is coupled, for example, to the deployment carriage. The first lever and the deployment carriage are coupled together such that a movement of the deployment carriage along the guide rail is transferred to the first lever.

The third lever is fixedly coupled, for example, to the guide rail, so that the third lever is pivotable relative to the guide rail. The third lever is also pivotably connected to the second lever.

The second lever in turn is pivotably connected, for example, to the deployment lever.

The arrangement with the deployment lever, the first lever, the second lever and the third lever thus forms a deployment mechanism in the manner of a four-bar linkage. The coupling of the levers together is such that the deployment lever is pivoted with a longitudinal displacement of the first lever. This pivoting in turn serves, in particular, for lifting and lowering a trailing edge of the cover in a upward direction. The upward direction runs, in particular, transversely or perpendicularly to the longitudinal direction. Due to the coupling of the levers together, a guide slider for pivoting the deployment lever can be dispensed with. This permits, in particular, a low-friction operation and reliably defined forces during the pivoting movement.

According to at least one embodiment, the deployment lever has a seventh end. The deployment lever is coupled to the guide rail at the seventh end. The deployment lever has an eighth end opposing the seventh end. The deployment lever can be coupled to the cover at the eighth end. The deployment lever and the second lever have a sixth rotary joint common to one another. The sixth rotary joint is arranged between the sixth end and the seventh end. In a central region of the deployment lever, the sixth rotary joint is configured with the second lever. The movement of the second lever in the longitudinal direction and in the upward direction thus leads to the pivoting of the deployment lever.

According to at least one embodiment, the first lever and the second lever are pivotably connected together by means of a fourth rotary joint.

According to at least one embodiment, the second lever is coupled at the third end to the first lever. The second lever is coupled at the fourth end by means of a third rotary joint to the third lever. The sixth rotary joint is arranged between the third end and the fourth end. The second lever is thus rotatable relative to the deployment lever so that the third end and the fourth end rotate about the sixth rotary joint.

According to at least one embodiment, the arrangement has an open position. In the open position, the deployment lever is arranged at its maximum pivoted position and oriented, in particular, substantially in the upward direction. In the open position, the cover is displaced to a maximum extent to the rear and a roof opening of the vehicle roof is opened up to a maximum extent. In the open position, the sixth rotary joint, the fifth end and the sixth end are arranged in a linear manner. The fifth end is arranged between the sixth rotary joint and the sixth end. This results in a dead centre position since the three movement points on the sixth rotary joint, the fifth end and the sixth end are arranged along a straight line. An external force thus cannot inadvertently lead to a pivoting of the deployment lever. Thus the open position can be held reliably without specific forces, for example, having to be taken up on the first lever.

According to at least one embodiment, the arrangement has a closed position. In the closed position, the deployment lever is oriented substantially in the longitudinal direction. In the closed position, the cover closes the roof opening. A leading edge and a trailing edge of the cover are oriented substantially flush with the remaining vehicle roof. In the closed position, the sixth rotary joint, the fifth end and the sixth end, are arranged in a linear manner. The sixth rotary joint is arranged between the fifth end and the sixth end. Thus in the closed position, the sixth rotary joint, the fifth end and the sixth end are also arranged along a straight line. This results in a dead centre position for the sixth rotary joint, the fifth end and the sixth end, also in the closed position. Thus the closed position is also securely held and an inadvertent opening of the cover can be reliably avoided.

According to at least one embodiment, the second lever has a main direction of extent. The second lever has a first portion and a second portion in its main direction of extent. The first portion and the second portion are arranged so as to be angled-back to one another. The first portion and the second portion are, in particular, rigid relative to one another so that the angle can be changed. The angled-back shape of the second lever permits a space-efficient arrangement and a reliable transfer of the linear movement of the sliding drive member to the pivoting movement of the deployment lever.

According to at least one embodiment, the first lever and the third lever are pivotably connected together by means of a fourth rotary joint.

According to at least one embodiment, the second lever is coupled at the third end to the deployment lever by means of a sixth rotary joint. The second lever is coupled at the fourth end to the third lever by means of a third rotary joint. The second lever is thus pivotable in each case relative to the deployment lever and relative to the third lever.

For example, in the open position the sixth rotary joint, the fourth end and the sixth end are arranged in a linear manner. In this embodiment, the fourth end is arranged between the sixth rotary joint and the sixth end. This results in a dead centre position, since the three movement points on the sixth rotary joint, the fourth end and the sixth end are arranged along a straight line. An external force thus cannot inadvertently lead to a pivoting of the deployment lever. Thus the open position can be reliably held without specific forces, for example, having to be taken up on the first lever.

For example, in the closed position, the sixth rotary joint, the fourth end and the sixth end are arranged in a linear manner. In this embodiment, the sixth end is arranged between the sixth rotary joint and the fourth end. Thus in the closed position the sixth rotary joint, the fourth end and the sixth end are also arranged along a straight line. This also results in a dead centre position for the sixth rotary joint, the fourth end and the sixth end in the closed position. Thus the closed position is securely held and an inadvertent opening of the cover can be reliably avoided.

According to at least one further embodiment, the first lever is coupled to the deployment carriage so as to be pivotable relative to the deployment carriage. The first lever, in particular, is coupled at the first end to the deployment carriage. The first lever and the deployment lever are rigidly coupled relative to one another in the longitudinal direction. A relative movement between the first lever and the deployment carriage in the longitudinal direction is blocked. Thus a longitudinal movement of the deployment carriage is reliably transferred to the first lever. The first lever follows a longitudinal movement of the deployment carriage. The pivotability of the first lever relative to the deployment carriage permits the pivoting of the deployment lever. Thus the linear movement of the deployment carriage can be transferred into the pivoting movement of the deployment lever.

According to at least one embodiment, the third lever is coupled at the fifth end to the second lever. The third lever is coupled at the sixth end to the guide rail. In particular, the third lever is fixedly coupled at the sixth end to the guide rail. The third lever is pivotable about the sixth end relative to the guide rail. The sixth end is fixedly connected to the guide rail so as to be rotatable relative to the guide rail.

According to at least one embodiment, the deployment lever and the third lever are coupled to the guide rail so as to be spaced apart from one another in the longitudinal direction. In particular, the fourth end and the sixth end are fixedly arranged relative to the guide rail so as to be spaced apart from one another in the longitudinal direction. The distance is constant and irrespective of the pivoting state of the deployment lever and/or the third lever.

According to at least one embodiment, the first lever has a main direction of extent. The first lever has a curved profile in its main direction of extent. This permits a space-efficient arrangement and sufficient travel for the eighth end between the closed position and the open position.

According to at least one embodiment, a vehicle roof for a motor vehicle has an arrangement according to at least one of the embodiments described herein. The vehicle roof has a cover. The deployment lever is coupled to the cover. The coupling is configured in order to move the cover by a displacement of the deployment carriage along the guide rail. In particular, the coupling is configured in order to lift and lower the cover in the upward direction by displacing the deployment carriage. In particular, a trailing edge of the cover can be lifted and lowered relative to the guide rail by means of the deployment lever.

### BRIEF DESCRIPTION OF DRAWINGS

Further advantages, features and developments are found in the following examples which are described in connection with the figures. Elements which are the same, similar or have the same function can be provided in all of the figures with the same reference signs.

In the drawings:

FIG. 1 shows a schematic view of a part of a vehicle according to an exemplary embodiment,

FIGS. 2 to 5 show in each case schematic views of an arrangement according to an exemplary embodiment in different views,

FIGS. 6 to 8 show in each case schematic views of an arrangement according to a further exemplary embodiment in different views, and

FIGS. 9 to 11 show in each case schematic views of an arrangement according to a further exemplary embodiment in different views.

### DETAILED DESCRIPTION

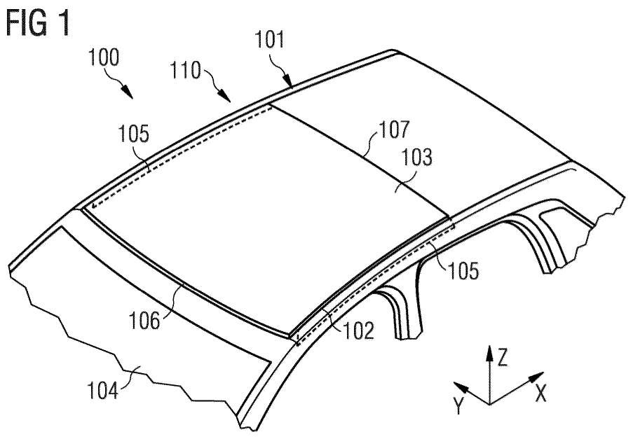

FIG. 1 shows a schematic view of a vehicle roof 101 of a vehicle 100. The vehicle roof 101, in particular, is part of the motor vehicle 100, for example part of a passenger motor vehicle. The vehicle roof 100 has an arrangement 110. The arrangement 110 has a cover 103. The cover 103 serves for closing a roof opening 102. The roof opening 102 is configured in the vehicle roof 101. By displacing the cover 103 in a longitudinal direction X the roof opening 102 can be closed in a closed position and at least partially opened up in an open position. The cover 103 is displaceable relative to a fixed roof of the vehicle roof 101 in the longitudinal direction X and a upward direction Y, oriented transversely thereto, between the closed position, which is shown in FIG. 1, and an open position. For the closure, the cover is moved counter to the longitudinal direction X.

The cover 103 has a leading edge 106 and a trailing edge 107. The trailing edge 107 is arranged in the longitudinal direction X opposing the leading edge 106 of the cover 103. The leading edge 106 of the cover 103 faces a windshield 104 of the vehicle 100.

The arrangement 110 has two guide rails 105. The guide rails 105 are extended in each case longitudinally in the longitudinal direction X. The guide rails 105 are arranged in each case in the transverse direction Y adjacent to the roof opening 102. In the transverse direction Y the guide rails 105 are coupled, for example, in each case to a body of the vehicle 100.

Positional information or directional information used, such as rear or front, relates to the vehicle longitudinal direction X. The vehicle longitudinal direction can also be denoted as the horizontal direction or X-direction of the mathematical right-handed system. The lifting or deployment of the cover 103 takes place in the upward direction Z, which can also be denoted as the vertical direction. Correspondingly, positional information or directional information, such as top or bottom, refers to the upward direction Z. The region of the leading edge 106 of the cover 103 (front region of the cover 103) is to be understood to mean, for example, the region which faces the windshield 104, starting from a centre of the cover in the longitudinal direction X. The longitudinal direction X, the transverse direction Y and the upward direction Z are in each case, in particular, perpendicular to one another.

The arrangement 110, in particular, is constructed on both sides of the roof opening 102 in an identical manner, in particular mirror-symmetrically and corresponding to one another. Hereinafter, one side is described and the opposing side in the transverse direction X is correspondingly configured in an identical manner.

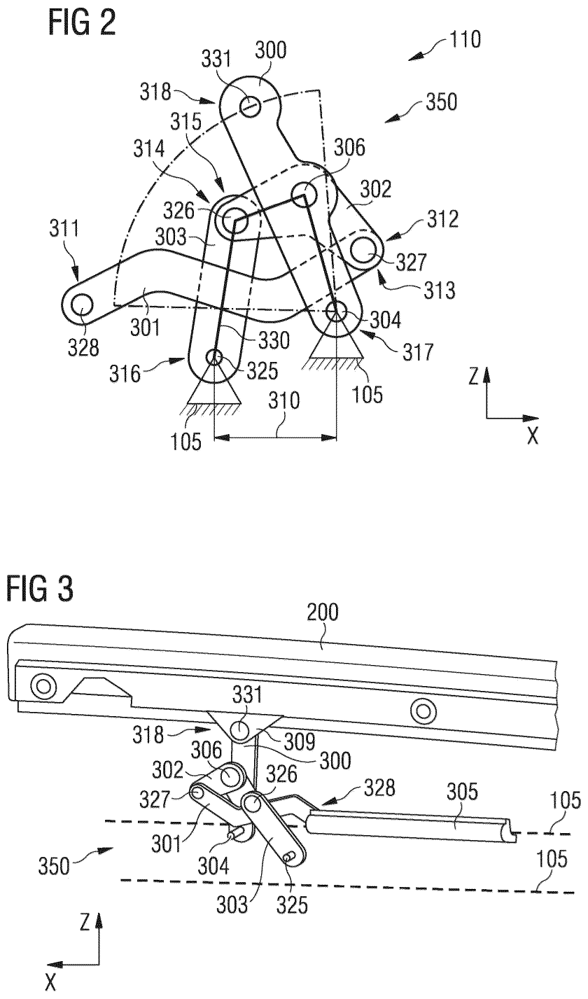

FIGS. 2 and 3 show the arrangement 110. The arrangement 110 has a joint mechanism 350.

The arrangement 110 has a first lever 301. The first lever extends between a first end 311 and a second opposing end 312 in the longitudinal direction X. The first lever 301 extends, in particular, between a deployment carriage 305 and a second lever 302.

The deployment carriage 305 is longitudinally displaceably guided in the guide rail 105. In particular, the deployment carriage 305 is displaceable to the front and rear relative to the guide rail 105 in the longitudinal direction X by means of a drive, not explicitly shown, for example by means of an electric motor.

The first lever 301 is connected at the first end 311 to the deployment carriage 305 so that the first end 311 of the first lever 301 follows a longitudinal movement of the deployment carriage 305. A pivoting of the first lever 301 is possible relative to the guide rail 105 and relative to the deployment carriage 305.

At the second end 312, the first lever 301 is connected to the second lever 302. The first lever 301 is connected at the second end 312 to a third end 313 of the second lever 312. The first lever 301 and the second lever 302 are pivotably connected relative to one another at the second end 312 and the third end 313.

The second lever 302 extends between the third end 313 and a fourth end 314. At the fourth end 314, the second lever 302 is connected to a third lever 303. The second lever 302 is connected to a fifth end 315 of the third lever 303. At the fourth end 314 and the fifth end 315, the second lever 302 and the third lever 303 are connected so as to be pivotable relative to one another.

The third lever 303 extends in a linear manner between the fifth end 315 and an opposing sixth end 316. The sixth end 316 is fixedly connected to the guide rail 105. At the sixth end 316, the third lever 303 is pivotable relative to the guide rail 105. A movement in the longitudinal direction X is, however, blocked.

The arrangement 110 has a deployment lever 300. The deployment lever 300 is fixedly connected at a seventh end 317 to the guide rail. The deployment lever 300 is pivotable relative to the guide rail at the seventh end 317. A longitudinal displacement of the seventh end 317 is blocked in the longitudinal direction X relative to the guide rail 105.

The deployment lever 300 extends so as to be longitudinally extended between the seventh end 317 and an opposing eighth end 318. The eighth end 318 can be coupled to a cover support 200. The cover support 200 is coupled to the cover 103 in order to support the cover 103. The coupling between the deployment lever 300 and the cover support 200 has a deployment lever slider 309. The deployment lever slider 309 is slidably guided in the cover support 200, so that the cover support 200 is displaceable in the longitudinal direction relative to the deployment lever slider 309. The deployment lever slider 309 for the deployment lever 300 is pivotably fastened to the deployment lever 300 at the eighth end 318 by means of a seventh rotary joint 331.

The deployment lever 300 is fastened to the guide rail 105 at the seventh end 317 by means of a rotary joint. The rotary joint permits the pivoting of the guide rail 105 and the deployment lever 300 relative to one another and blocks a longitudinal displacement in the longitudinal direction.

A sixth rotary joint 306 is provided in a central region of the deployment lever 300 between the seventh end 317 and the eighth end 318. At the sixth rotary joint 306, the deployment lever 300 is coupled to the second lever 302. The sixth rotary joint 306 fastens the deployment lever 300 and the second lever 302 to one another so that a pivoting of the deployment lever 300 and the second lever 302 relative to one another is possible. A longitudinal displacement is blocked by means of the sixth rotary joint 306. The sixth rotary joint 306 is arranged in a central region of the second lever 302 between the third end 313 and the fourth end 314.

The third lever 303 is fixedly fastened to the guide rail 105 by means of a second rotary joint 325. The second rotary joint 325 permits the pivoting of the second lever 303 and the guide rail 105 relative to one another. A longitudinal displacement in the longitudinal direction X is blocked.

The third lever 303 and the second lever 302 are fastened to one another by means of a third rotary joint 326. The third rotary joint 326 permits the pivoting of the third lever 303 and the second lever 302 relative to one another. A longitudinal displacement in the longitudinal direction X is blocked.

The second lever 302 and the first lever 301 are fastened to one another by means of a fourth rotary joint 327. The fourth rotary joint 327 permits the pivoting of the second lever 302 and the first lever 301 relative to one another. A longitudinal displacement between the second lever 302 and the first lever 301 is blocked in the longitudinal direction X.

The first lever 301 is fastened to the deployment carriage 305 by means of a fifth rotary joint 328. The fifth rotary joint 328 permits the pivoting of the first lever 301 and the deployment carriage 305 relative to one another. A longitudinal displacement of the first lever 301 and the deployment carriage 305 relative to one another in the longitudinal direction X is blocked by means of the fifth rotary joint 328.

The rotary joint 304 for fastening the deployment lever 300 and the second rotary joint 325 for fastening the third lever 303, in each case to the guide rail 105, are arranged spaced apart from one another with a distance 310 in the longitudinal direction X. For example, the rotary joint 304 and the second rotary joint 325 are also arranged offset to one another in the upward direction Z. For example, the second rotary joint 325 is arranged below the rotary joint 304 in the upward direction Z. The second rotary joint 325 is arranged, for example, further to the front than the rotary joint 304 in the longitudinal direction X.

The deployment lever 300, the first lever 301, the second lever 302 and the third lever 303 are part of a common four-part linkage. The first lever 301, the second lever 302 and the third lever 303 are used in order to pivot the deployment lever 300. By pivoting the deployment lever 300, the cover support 200 can be lifted and lowered relative to the guide rail 105 in the upward direction Z. In particular, by pivoting the deployment lever 300 the trailing edge 107 of the cover 103 can be lifted and lowered relative to the guide rail 105 in the upward direction Z.

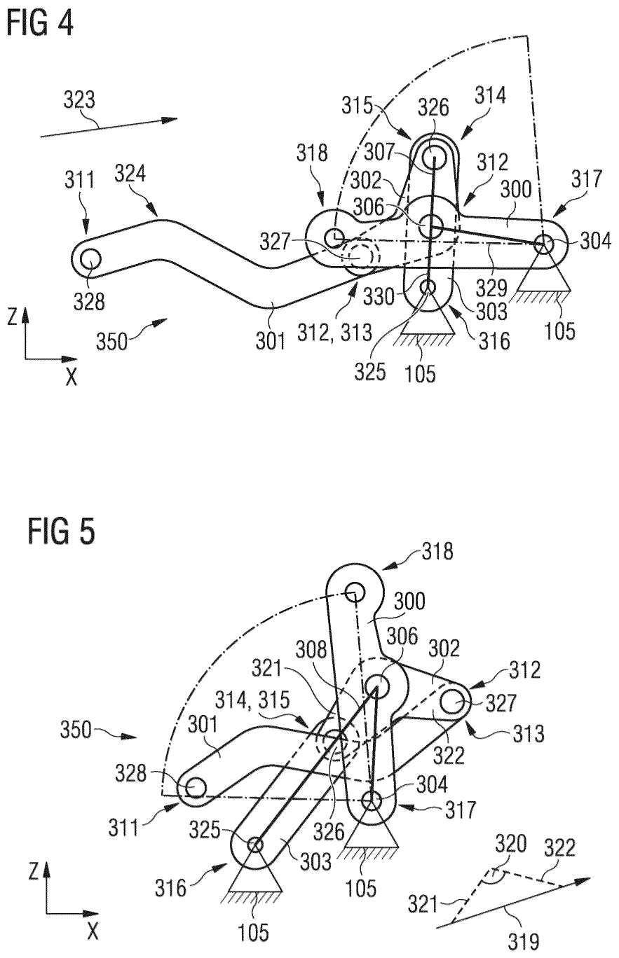

FIG. 4 shows the arrangement 110 and the joint mechanism 350 in a closed position. In the closed position, the cover 103 closes the roof opening 102. Starting from the closed position, the cover 103 can be lifted in the longitudinal direction Z and displaced to the rear in the longitudinal direction X, i.e. in a direction away from the windshield 104.

Initially, starting from the closed position, the trailing edge 107 of the cover can be lifted by means of the deployment lever 300, wherein the leading edge 106 is not yet substantially lifted over the remaining vehicle roof 101. This position is denoted as the tilted position.

Subsequently, the leading edge 106 can also be lifted and the entire cover 103 displaced to the rear in the longitudinal direction X in order to open up the roof opening. This so-called open position is shown in FIG. 5.

In the closed position according to FIG. 4, the deployment lever 300 is pivoted-in so that a main direction of extent 329 of the deployment lever 300 substantially runs in the longitudinal direction X. The eighth end 318 is arranged in the vicinity of the guide rail 105. Thus the cover 103 is held in the vicinity on the guide rail 105.

The third lever 303 is oriented such that the fifth end 315 is arranged in the upward direction Z above the sixth end 316. A main direction of extent 330 of the third lever 303 runs substantially in the upward direction Z. Thus the third lever 303 is reliably supported in the upward direction Z and, in particular, without relevant torque on the guide rail 105.

In the closed position, the sixth rotary joint 306 is arranged in the upward direction Z between the second rotary joint 325 and the third rotary joint 326. The second rotary joint 325, the sixth rotary joint 306 and the third rotary joint 326 are arranged along a straight line 307. The straight line 307 runs substantially in the upward direction Z. The fifth end 315, the sixth rotary joint 306 and the sixth end 316 are arranged on the straight line 307. Thus a pivoting of the deployment lever 300 and, in particular, a lifting of the eighth end 318 is not possible without the action of an external torque by means of the second lever 302. The sixth rotary joint 306, the second rotary joint 325 and the third rotary joint 326 are in a dead centre position. Thus the cover 103 is securely held in the closed position.

Starting from the closed position in FIG. 4, the arrangement 110 is moved for lifting the trailing edge 107 into the open position according to FIG. 5. This movement, in particular, is driven by a longitudinal movement of the deployment carriage 305 relative to the guide rail 105 to the rear, i.e. in particular away from the windshield 104. The displacement of the deployment carriage 305 causes a displacement of the first end 311 of the first lever 301. Thus the second end 312 of the first lever 301 is displaced in the longitudinal direction X and the first lever 301 is pivoted relative to the guide rail about the fifth rotary joint 328. The coupling of the first lever 301, the second lever 302, the third lever 303 and the deployment lever 300 causes the linear movement of the deployment carriage 305 to be transferred into the different pivoting movements of the levers 300, 301, 302, 303.

The second end 312 initially moves in the longitudinal direction in the direction of the rotary joint 304 and beyond. In the closed position, the second end 312 is arranged in front of the rotary joint 304. In the open position, the second end 312 is arranged behind the rotary joint 304 in each case in the longitudinal direction X.

This displacement of the second end 312 and thus also the fourth rotary joint 327 causes a movement and rotation of the second lever 302. Since this second lever is connected at the fourth end 314 to the third lever 303 and is connected at the sixth rotary joint 306 to the deployment lever 300, the displacement of the second end 312 by means of the second lever 302 and the third lever 303 is converted into the pivoting movement of the deployment lever 300.

In the open position, the sixth rotary joint 306, the third rotary joint 326 and the second rotary joint 325 are arranged along a straight line 308. The third rotary joint 326 is arranged along the straight line 308 between the sixth rotary joint 306 and the second rotary joint 325. The sixth end 316 and the fifth end 315 and the sixth rotary joint 306 are arranged along the straight line 308. The fourth end 314 and the fifth end 315 are arranged between the sixth rotary joint 306 and the second rotary joint 325 on the straight line 308. The straight line 308 connects the second rotary joint 325 and the sixth rotary joint 306. In the closed position, the third rotary joint 326 and the sixth rotary joint 306 are arranged substantially in the upward direction Z on top of one another on the straight line 307.

In the open position, the sixth rotary joint 306 is arranged between the third rotary joint 326 and the fourth rotary joint 327 in the longitudinal direction X.

In the closed position, the fourth rotary joint 327 is arranged in front of the sixth rotary joint 306 and in the open position behind the sixth rotary joint 306 in the longitudinal direction X.

In the open position, the third rotary joint 326 is arranged between the rotary joint 304 and the second rotary joint 325 in the longitudinal direction X. The sixth rotary joint 306 is arranged in the upward direction Z above the rotary joint 304. The third rotary joint 326 is arranged on the straight line 306 between the sixth rotary joint 306 and the second rotary joint 325. This results in a dead centre position for the sixth rotary joint 306, the third rotary joint 326 and the second rotary joint 325. The pivoted-out position of the deployment lever 300 is thus held in a stable manner in the tilted position and in the open position. Without an action of a torque by means of the second lever 302, the deployment lever 300 is reliably held in its pivoted-out position and the cover 103 is supported in a stable manner.

The second lever 302 has a main direction of extent 319 which is shown schematically in FIG. 5. The second lever 302 has a first portion 321 and a second portion 322 which are also shown schematically in FIG. 5 for greater clarity. The fourth end 314 of the second lever 302 is configured on the first portion 321. The second end 312 is configured on the second portion 322. The sixth rotary joint 306 is configured in a central region in which the first portion 321 and the second portion 322 adjoin one another. The first portion 321 and the second portion 322 are at an angle 320 to one another. In particular, a connecting line between the sixth rotary joint 306 and the third rotary joint 326 is at the angle 320 from a connecting line between the sixth rotary joint 306 and the fourth rotary joint 327. The angle 320 has, in particular, a value of greater than 90° and less than 180°. The sixth rotary joint 306, the third rotary joint 326 and the fourth rotary joint 327 are thus arranged in a triangular shape relative to one another.

The first lever 301 has a main direction of extent 323. The main direction of extent 323 of the first lever 301 is shown schematically in FIG. 4. In the main direction of extent 323 the first lever 301 has a curved profile 324. The first lever 301 thus does not run along a single straight line but has portions which run at an angle to one another. Thus a space-efficient arrangement of the third rotary joint 326, the fourth rotary joint 327 and, in particular, the sixth rotary joint 306 is possible relative to one another. In particular, the curved profile 324 permits the first lever 301 in the open position to run below the second lever 302 and the fourth rotary joint 327 can still be produced. In the open position, the third rotary joint 326 is also arranged above the first lever 301.

The deployment lever 300, which is designed as a movable link of the four-bar linkage, is used for lifting and lowering the cover 103 in the rear region on the trailing edge 107. The two other links, i.e. the second lever 302 and the third lever 303, of the four-part linkage are arranged such that in each case a dead centre point results in the closed position and in the open position, i.e. in the respective end positions, of the deployment lever 300.

The drive takes place by means of the first lever which is connected to the second lever 302. In an alternative exemplary embodiment, which is not explicitly shown in the figures, the first lever 301 is pivotably coupled to the sixth end 316 of the third lever 303. Accordingly, in this exemplary embodiment the second end 312 of the second lever 302 is fixedly connected to the guide rail 105 so as to be pivotable.

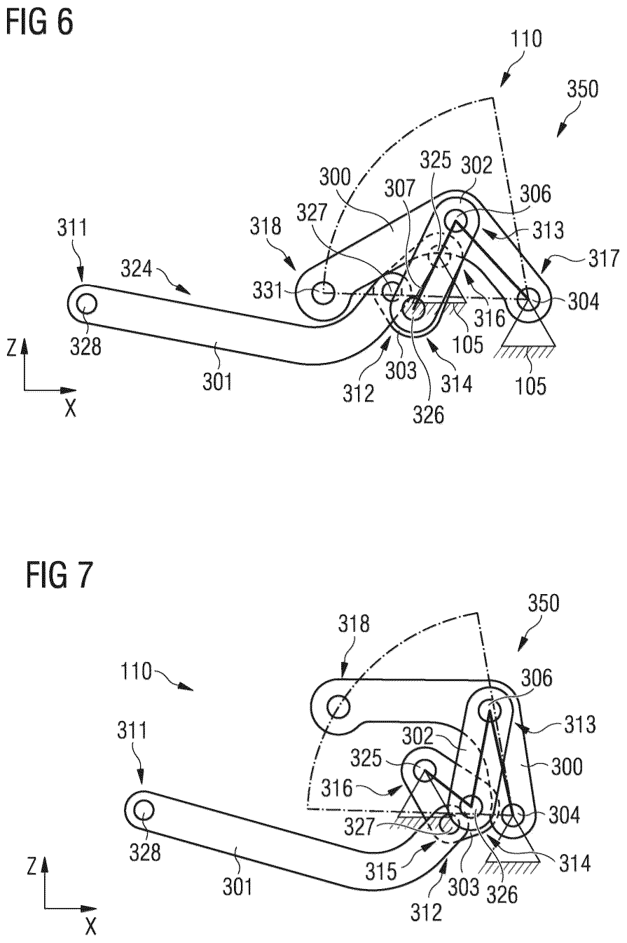

FIGS. 6 to 8 show the arrangement 100 with the joint mechanism 350 according to a further exemplary embodiment. The functionality and design of the joint mechanism 350 corresponds substantially to the exemplary embodiment according to FIGS. 2 to 5

In contrast to the exemplary embodiment according to FIGS. 2 to 5, the first lever 301 is pivotably connected by the fourth rotary joint 327 to the third lever 303. The second lever 302 extends in a linear manner between the third rotary joint 326 and the sixth rotary joint 306. The second lever 302 is connected to two rotary joints 306, 326. The third lever 303 is connected to three rotary joints 325, 326, 327.

The third lever 303 has a triangular basic shape. The third rotary joint 326 and the fourth rotary joint 327 are at a smaller distance from one another than the second rotary joint 325 from the third rotary joint 326 and than the second rotary joint 325 from the fourth rotary joint 327.

The deployment lever 300 has an angled path. The seventh end 317 of the deployment lever 300 is configured on a first portion of the deployment lever 300. The eighth end 318 is configured on a second portion of the deployment lever 300. The sixth rotary joint 306 is configured in a central region in which the first portion and the second portion adjoin one another. The first portion and the second portion are at an angle to one another. In particular, a connecting line between the sixth rotary joint 306 and the first rotary joint 304 are at the angle from a connecting line between the sixth rotary joint 306 and the seventh rotary joint 331. The angle 320 has, in particular, a value of greater than 90° and less than 180°. The sixth rotary joint 306, the third rotary joint 326 and the fourth rotary joint 327 are thus arranged in a triangular shape to one another.

FIG. 6 shows the arrangement 110 in the closed position. The third rotary joint 326, the second rotary joint 325 and the sixth rotary joint 306 are arranged along the straight line 307. The second rotary joint 325 is arranged along the straight line 307 between the third rotary joint 326 and the sixth rotary joint 306. Thus a pivoting of the deployment lever 300 and, in particular, a lifting of the eighth end 318 is not possible without the action of an external torque by means of the second lever 302. The sixth rotary joint 306, the second rotary joint 325 and the third rotary joint 326 are in a dead centre position. Thus the cover 103 is securely held in the closed position.

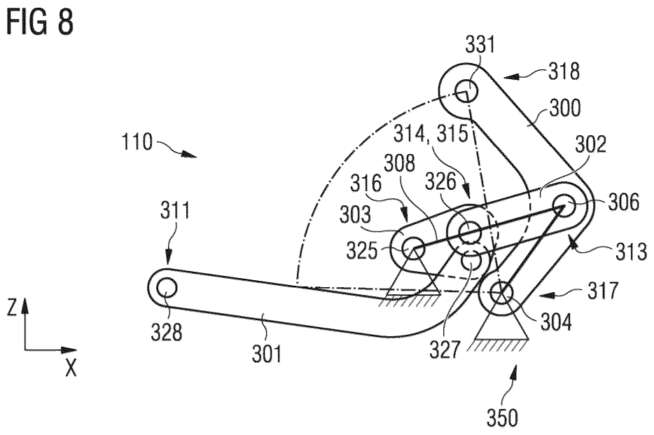

FIG. 8 shows the arrangement 110 in the open position. The sixth rotary joint 306, the third rotary joint 326 and the second rotary joint 325 are arranged along the straight line 308. The third rotary joint 326 is arranged along the straight line 308 between the second rotary joint 325 and the sixth rotary joint 306. This results in a dead centre position for the sixth rotary joint 306, the third rotary joint 326 and the second rotary joint 325. The pivoted-out position of the deployment lever 300 is thus held in a stable manner in the tilted position and in the open position. Without the action of a torque by means of the second lever 302, the deployment lever 300 is reliably held in its pivoted-out position and the cover 103 is supported in a stable manner.

FIG. 7 shows the arrangement 110 in an intermediate position between the open position and the closed position.

FIGS. 9 to 11 show the arrangement 100 with the joint mechanism 350 according to a further exemplary embodiment. The functionality and design of the joint mechanism 350 corresponds substantially to the exemplary embodiment according to FIGS. 2 to 8.

The first lever 301 is pivotally connected to the third lever 303 by means of the fourth rotary joint 327. The second lever 302 extends in a straight line between the third rotary joint 326 and the sixth rotary joint 306. The second lever 302 is connected to two rotary joints 306, 326. The third lever 303 is connected to three rotary joints 325, 326, 327.

The third lever 303 has a basic triangular shape. The deployment lever 300 is attached to the guide rail 105 in a fixed position by means of the first rotary joint 304. The third lever 303 is attached to the guide rail 105 by means of the second rotary joint 325 so as to be able to pivot in a fixed position. The third rotary joint 326 and the fourth rotary joint 327 are at a greater distance from one another than the second rotary joint 325 is from the third rotary joint 326 and than the second rotary joint 325 is from the fourth rotary joint 327.

The deployment lever 300 has an angled shape. The seventh end 317 of the deployment lever 300 is formed at a first portion of the deployment lever 300. The eighth end 318 is formed on a second portion of the deployment lever 300. The first rotary joint 304 is formed at a centre portion where the first portion and the second portion are adjacent to each other. The first portion and the second portion are at an angle to each other. In particular, a connecting line between the sixth rotary joint 306 and the first rotary joint 304 has an angle to a connecting line between the sixth rotary joint 306 and the seventh rotary joint 331. In particular, the angle 320 has a value of greater than 90° and less than 180°. The sixth rotary joint 306, the third rotary joint 326 and the fourth rotary joint 327 are thus arranged in a triangular shape relative to one another. The sixth rotary joint 306 is arranged at the seventh end 317. The seventh rotary joint 331 is arranged at the eighth end 318. Between the closed position and the open position, the sixth rotary joint 306 moves under the first rotary joint 304 in a circular path around the first rotary joint 304.

The first rotary joint 304 is arranged along the longitudinal direction X between the fifth rotary joint 328 and the second rotary joint 325. The second rotary joint 325 is arranged behind the first rotary joint 304 in the longitudinal direction X.

As in the embodiment example according to FIGS. 2 to 8, the joint mechanism 350 according to the embodiment example of FIGS. 9 to 11 has at least four rotary joints and is in particular designed as a seven-bar linkage.

FIG. 9 shows the arrangement 110 in the closed position. The third rotary joint 326, the second rotary joint 325 and the sixth rotary joint 306 are arranged along the straight line 307. The second rotary joint 325 is arranged along the straight line 307 between the third rotary joint 326 and the sixth rotary joint 306. Thus, pivoting of the deployment lever 300 and, in particular, lifting of the eighth end 318 is not possible without the action of an external torque by means of the second lever 302. The sixth rotary joint 306, the second rotary joint 325 and the third rotary joint 326 are in a dead centre position. Thus, the cover 103 is securely held in the closed position.

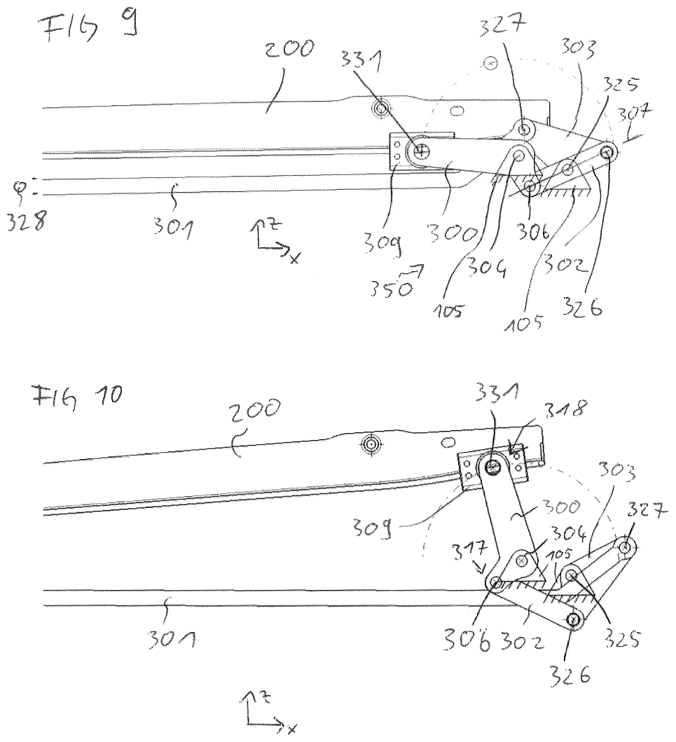

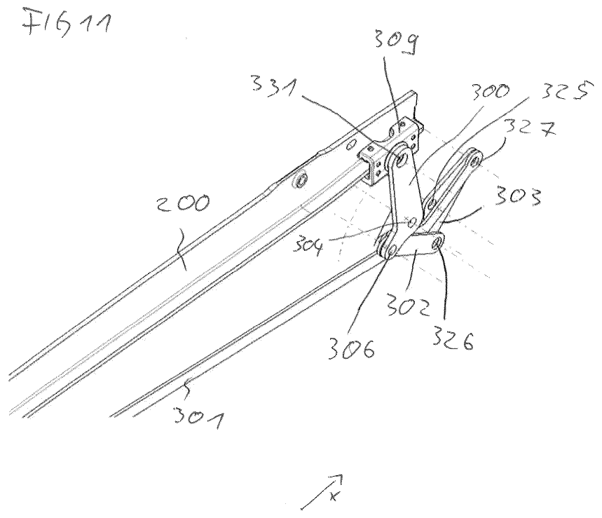

FIGS. 10 and 11 each show the arrangement 110 in the open position. In the open position, the amount of force acting on the deployment lever 300 along the upward direction Z is small. There is no force from a seal acting on the cover 103 and only a small force resulting from the wind load.

Since the deployment lever 300 and the force along the upward direction Z have similar orientations, the proportion of the force acting along the longitudinal direction X is low. This means that only this small force needs to be transmitted to the drive by means of the joint mechanism 350. It is also possible for the deployment lever 300 to be aligned in the same direction as the force along the upward direction Z and the proportion along the longitudinal direction X is zero. In this case, no force acting along the longitudinal direction X needs to be transmitted to the drive.

In the closed position, the amount of force acting on the deployment lever 300 along the upward direction Z is large. When the cover 103 is closed, especially at high speed, a suction acts on the cover 103, which leads to the force component acting upwards. This force varies depending on the position of the cover and increases sharply towards the end of the closing movement. As the seal of the roof system must also be compressed at this point, additional force must be applied by the drive. Due to the arrangement of the levers 300, 301, 302, 303 and the associated rotary joints, the force required to close the cover 103 can be reliably applied.

Since the rotary joints 206, 325, 326 are aligned along the straight line 307 in the closed position, the force acting along the upward direction Z on the deployment lever 300 does not result in any force acting along the longitudinal direction X on the drive.

If the speed of the drive remains constant, the joint mechanism 350, in particular the deployment carriage 305, moves more slowly at the beginning and at the end of the movement for pivoting the deployment lever 300 than in between. A good transmission ratio can be achieved, particularly near the closing position. When closing, the joint mechanism 350 requires significantly less drive force than conventional mechanisms with gate couplings. Due to the lower force requirement, either a weaker drive can be used with the same speed and/or the same cover size. The same drive can also be used for larger covers and/or greater vehicle speeds in order to still be able to reliably close the cover 103.

The arrangement 100 according to the different exemplary embodiments permits a pivoting of the deployment lever 300, and thus a lifting and lowering of the trailing edge 107, merely by using rotary joints and avoiding guide sliders. In the case of higher loads, this also permits relatively small torques for overcoming the bearing friction in the rotary joints 304, 306 and 325 to 328. This bearing friction, in particular, is significantly smaller than the friction in a guide slider.

The arrangement 110 has the joint mechanism 350 for lifting and lowering the trailing edge 107. The joint mechanism 350 has at least three rotary joints in order to connect the levers 300, 301, 302, 303 pivotably together. The joint mechanism 350 has at least the third rotary joint 326, the fourth rotary joint 327 and the sixth rotary joint 306.

The joint mechanism, for example, also has the fifth joint 328 in order to connect the first lever 301 pivotably to the deployment carriage 305. The joint mechanism, for example, also has the first rotary joint 304 and the second rotary joint 325 which are in each case fixed to the guide rail 105. The joint mechanism, for example, also has the seventh rotary joint in order to connect the deployment lever 300 and the deployment lever slider 309 pivotably together. A pivoting of the deployment lever 300 and the cover support 200 relative to one another is possible by means of the seventh rotary joint. The joint mechanism 350 is thus configured in the manner of a multi-bar linkage, in particular in the manner of a four-bar linkage.

Small bearing clearances in the rotary joints 304, 306 and 325 to 328 are implemented reliably in terms of technology. This permits an efficient cause analysis to be made in the case of occurring errors, such as sluggishness, rattling and/or jolting, and corresponding engagement options in order to eliminate these errors.

Starting from the closed position according to FIG. 4 or FIG. 6, initially a relatively small drive force requirement is necessary for deploying the deployment lever 300. At the start of the deployment movement of the deployment lever 300, for example, the bearing friction has to be substantially overcome. A relatively significant displacement of the deployment carriage 305 leads to a relatively small pivoting of the deployment lever 300. Thus the pivoting of the deployment lever 300 can be implemented by a relatively small expenditure of force on the deployment carriage 305.

During the further course of the pivoting movement 300, for example in the range according to FIG. 2 or FIG. 7, the drive force requirement rises continuously to a maximum and drops again to a lower level before reaching the open position according to FIG. 5 or FIG. 8, in particular the drive force requirement continuously decreases.

In the central movement portion, for pivoting the deployment lever 300, a relatively small travel of the deployment carriage 305 in the longitudinal direction X relative to the guide rail 105 is converted into a large pivoting movement of the deployment lever 300, for which the large drive force requirement is necessary.

Subsequently, a relatively significant displacement of the deployment carriage 305 along the guide rail 105 is in turn converted into a smaller pivoting of the deployment lever 300 until the end position according to Figure or FIG. 8 is reached. To this end, in turn the lower drive force requirement is sufficient.

The drive force path along the entire pivoting movement of the deployment lever 300 is known and, for example, can be stored in a control device for the drive. The known and, in particular, continuous drive force path permits simple and efficient obstacle detection, such as for example reliable anti-trap protection. A control device does not have to differentiate between increased friction, which occurs for example with guide sliders, and a rise in the drive force requirement due to an obstacle. In particular, at any time of the pivoting movement of the drive lever 300 it is known which drive force requirement is necessary for obstacle-free pivoting. In the event of a deviation from this drive force requirement, an obstacle can be easily detected.

With a movement from the open position to the closed position, in particular at the end of the closing movement, high forces can occur due to wind load and sealing pressure which lead to a higher drive force requirement for the final closing of the cover 103 in the roof opening 102. This is compensated by the transmission configured by the four-bar linkage. The relatively large travel of the deployment carriage 305 along the guide rail 105 only has to bring about a small pivoting of the deployment lever 300 to the closed position according to FIG. 4 or FIG. 6.

The deployment lever 300 is configured with a reliable level of stiffness in the transverse direction X. Thus the arrangement 110 with the cover 103 can be implemented with good vibration behaviour.

In the end positions according to FIGS. 4 and 5 or FIGS. 6 and 8, the four-bar linkage of the joint mechanism 350 cannot be driven by means of the deployment lever 300. The deployment lever 300 is locked in the end positions. Thus it is possible to dispense with additional locking, in particular of the first lever 301, in the end positions according to FIGS. 4 and 5 or FIGS. 6 and 8.

The cover support 200 is configured in one piece, in particular in the manner of a conventional cover support. It is also possible to configure the cover support in multiple parts and with cover support rails which can be displaced relative to one another during operation in the longitudinal direction X.

The deployment carriage 305, in particular, is directly attached to a tensionally rigid and compression-resistant drive cable, not explicitly shown. The drive cable in turn is connected to the drive, i.e. in particular to the electric motor, in order to transfer the drive energy of the electric motor to the deployment carriage 305.

The arrangement 110 permits a reliable, low-friction and force-efficient pivoting of the deployment lever 300.

### REFERENCE SIGNS

100 Vehicle
101 Vehicle roof
102 Roof opening
103 Cover
104 Windshield
105 Guide rail
106 Leading edge
107 Trailing edge
110 Arrangement
200 Cover support
300 Deployment lever
301 First lever
302 Second lever
303 Third lever
304 First rotary joint
305 Deployment carriage
306 Sixth rotary joint
307, 308 Straight line
309 Deployment lever slider
310 Distance
311 First end
312 Second end
313 Third end
314 Fourth end
315 Fifth end
316 Sixth end
317 Seventh end
318 Eighth end
319 Main direction of extent of second lever
320 Angle
321 First portion
322 Second portion
323 Main direction of extent of first lever
324 Curved profile
325 Second rotary joint
326 Third rotary joint
327 Fourth rotary joint
328 Fifth rotary joint
329 Main direction of extent of deployment lever
330 Main direction of extent of third lever
331 Seventh rotary joint
350 Joint mechanism
X Longitudinal direction
Y Transverse direction
Z Upward direction

1. Arrangement for moving a cover for a vehicle roof, having:
a guide rail which extends in a longitudinal direction,
a deployment lever which is fixedly coupled to the guide rail so that the deployment lever can be pivoted relative to the guide rail in order to move the cover,
a deployment carriage which is guided in the guide rail so as to be displaceable in the longitudinal direction, wherein the deployment lever and the deployment carriage are coupled together by means of a joint mechanism in order to transfer a displacement of the deployment carriage along the guide rail into a pivoting of the deployment lever, wherein the joint mechanism has at least four rotary joints.

2. Arrangement according to claim 1, having:
a first lever with a first end and an opposing second end,
a second lever with a third end and an opposing fourth end, and
a third lever with a fifth end and an opposing sixth end, wherein
the first lever is coupled to the deployment carriage such that a movement of the deployment carriage along the guide rail is transferred to the first lever,
the third lever is fixedly coupled to the guide rail so as to be pivotable, so that the third lever is pivotable relative to the guide rail and the third lever is pivotably connected to the second lever,
the second lever is pivotably connected to the deployment lever.

3. Arrangement according to claim 2, wherein the deployment lever has a seventh end at which the deployment lever is coupled to the guide rail, and has an opposing eighth end at which the deployment lever can be coupled to the cover and wherein the deployment lever has a common sixth rotary joint with the second lever which is arranged between the sixth end and the seventh end.

4. Arrangement according to claim 2, wherein the first lever and the second lever are pivotably connected together by means of a fourth rotary joint.

5. Arrangement according to claim 4, wherein the second lever is coupled at the third end to the first lever and is coupled at the fourth end by means of a third rotary joint to the third lever and wherein the sixth rotary joint is arranged between the third end and the fourth end.

6. Arrangement according to claim 4, wherein in an open position of the arrangement the sixth rotary joint, the fifth end and the sixth end are arranged in a linear manner, wherein the fifth end is arranged between the sixth rotary joint and the sixth end.

7. Arrangement according to claim 4, wherein in a closed position of the arrangement the sixth rotary joint, the fifth end and the sixth end are arranged in a linear manner, wherein the sixth rotary joint is arranged between the fifth end and the sixth end.

8. Arrangement according to claim 4, wherein the second lever has a first portion and a second portion in its main direction of extent, wherein the first portion and the second portion are arranged so as to be angled back to one another.

9. Arrangement according to claim 2, wherein the first lever and the third lever are pivotably connected together by means of a fourth rotary joint.

10. Arrangement according to claim 9, wherein the second lever is coupled at the third end to the deployment lever by means of a sixth rotary joint and is coupled at the fourth end to the third lever by means of a third rotary joint.

11. Arrangement according to claim 9, wherein in an open position of the arrangement the sixth rotary joint, the fourth end and the sixth end are arranged in a linear manner, wherein the fourth end is arranged between the sixth rotary joint and the sixth end.

12. Arrangement according to claim 9, wherein in a closed position of the arrangement the sixth rotary joint, the fourth end and the sixth end are arranged in a linear manner, wherein the sixth end is arranged between the fourth end and the sixth rotary joint.

13. Arrangement according to claim 2, wherein the first lever is coupled at the first end to the deployment carriage so as to be pivotable relative to the deployment carriage, wherein the first lever and the deployment carriage are rigidly coupled relative to one another in the longitudinal direction.

14. Arrangement according to claim 2, wherein the third lever is coupled at the fifth end to the second lever and is coupled at the sixth end to the guide rail.

15. Arrangement according to claim 1, wherein the deployment lever and the third lever are coupled to the guide rail so as to be spaced apart from one another in the longitudinal direction.

16. Arrangement according to claim 1, wherein the first lever has a curved profile in its main direction of extent.

17. Vehicle roof having:
an arrangement according to claim 1,
a cover, wherein the deployment lever is coupled to the cover in order to move the cover by a displacement of the deployment carriage along the guide rail.
